(19) United States
(12) Patent Application Publication
(10) Pub. No.: US 2009/0176916 A1
(43) Pub. Date: Jul. 9, 2009

(54) RUBBER COMPOSITION AND VIBRATION-PROOF MATERIAL

(75) Inventors: Sadayuki Nakano, Ichihara-shi (JP); Toyohisa Tohyama, Toyoake-shi (JP); Fumihiko Jinno, Kasugai-shi (JP)

Correspondence Address: SUGHRUE MION, PLLC, 2100 PENNSYLVANIA AVENUE, N.W., SUITE 800, WASHINGTON, DC, 20037, US

(73) Assignees: SUMITOMO CHEMICAL COMPANY, LIMITED, Tokyo (JP); TOKAI RUBBER INDUSTRIES, LTD., Komaki-shi (JP)

(21) Appl. No.: 12/326,257

(22) Filed: Dec. 2, 2008

(30) Foreign Application Priority Data
Dec. 4, 2007 (JP) 2007-313361

(51) Int. Cl. C08K 5/18

(52) U.S. Cl. 524/186

(57) ABSTRACT

There is provided a rubber composition containing the following components: (A): an ethylene-α-olefin-nonconjugated polyene copolymer rubber, (B): a natural rubber, (C): an organic peroxide, (D): an aromatic amine compound, and (E): silica.

### BACKGROUND OF THE INVENTION

1. Field of the Invention

The present invention relates to a rubber composition and a vibration-proof material.

2. Related Background Art

In automobiles, various types of vibration-proof materials are used for reducing vibrations of engines and attendant noises. The vibration proofness is undoubtedly demanded for vibration-proof materials; since the temperature of environment of use becomes high due to heat generation of engines, the heat resistance is demanded; and the durability to repeating external forces over a long period is demanded.

Sine highly unsaturated rubbers such as natural rubber (NR) and styrene-butadiene copolymer rubber (SBR) are excellent in the vibration proofness and durability, the highly unsaturated rubbers are conventionally used for raw material rubbers of vibration-proof materials. However, the recent elevation in temperature of the using environment demands higher heat resistance and conventional vibration-proof materials using highly unsaturated rubbers as raw material rubbers have become unable to sufficiently meet this demand.

On the other hand, although lowly unsaturated rubbers such as ethylene-α-olefin-nonconjugated diene copolymer rubber are inferior in the durability to highly unsaturated rubbers, the lowly unsaturated rubbers are known to be superior in the heat resistance to the highly unsaturated rubbers. For meeting the above-mentioned demand for the improved heat resistance, attempts are nowadays made in which the lowly unsaturated rubbers are used as raw material rubbers of vibration-proof materials, and methods of improving the durability of vibration-proof materials using lowly unsaturated rubbers as raw material rubbers are variously studied.

For example, Japanese Patent Laid-Open No. 3-227343 proposes a rubber composition in which a high molecular weight rubber is used as an ethylene-propylene-nonconjugated diene copolymer rubber and a carbon black having a high structure is added, and a vibration-proof material obtained by vulcanizing the rubber composition. Further, Japanese Patent Laid-Open Nos. 6-200096 and 2006-193714 propose rubber compositions in which an ethylene-propylene-nonconjugated diene copolymer rubber is added with a natural rubber and a carbon black, and vibration-proof materials obtained by vulcanizing the rubber compositions.

### SUMMARY OF THE INVENTION

However, the above-mentioned vibration-proof materials are not sufficiently satisfactory in a balance among the vibration proofness, durability and heat resistance. In such a situation, an object for the present invention to solve is to provide a rubber composition in which an ethylene-α-olefin-nonconjugated polyene copolymer rubber is used as a raw material rubber, and which can provide a vibration-proof material excellent in a balance among the vibration proofness, durability and heat resistance obtained by vulcanizing the rubber composition, and to provide a vibration-proof material obtained by vulcanizing the rubber composition.

The present invention provides a rubber composition containing the following components, (A), (B), (C), (D) and (E). Vulcanizing the rubber composition of the present invention enables fabrication of a vibration-proof material sufficiently excellent in a balance, among the vibration proofness, durability and heat resistance.

(A): An ethylene-α-olefin-nonconjugated polyene copolymer rubber

(B): A natural rubber

(C): An organic peroxide

(D): An aromatic amine compound

(E): Silica

The present invention also provides a vibration-proof material obtained by vulcanizing the above-mentioned rubber composition. Such a vibration-proof material is excellent in a balance among the vibration proofness, durability and heat resistance.

### DESCRIPTION OF THE PREFERRED EMBODIMENTS

The present invention provides a rubber composition containing the following components, (A), (B), (C), (D) and (E).

The component (A) is an ethylene-α-olefin-nonconjugated polyene copolymer rubber. The α-olefins are exemplified by propylene, 1-butene, 1-pentene, 1-hexene, 4-methyl-1-pentene, 1-octene and 1-decene. The α-olefin is preferably an α-olefin having 3 to 20 carbon atoms, and more preferably propylene and 1-butene.

The nonconjugated polyenes include nonconjugated dienes and nonconjugated trienes. The nonconjugated dienes are exemplified by linear nonconjugated dienes such as 1,4-hexadiene, 1,6-octadiene, 2-methyl-1,5-hexadiene, 6-methyl-1,5-heptadiene and 7-methyl-1,6-octadiene; and cyclic nonconjugated dienes such as cyclohexadiene, dicyclopentadiene, methyltetraindene, 5-vinylnorbornene, 5-ethylidene-2-norbornene and 6-chloromethyl-5-isopropenyl-2-norbornene. Nonconjugated trienes are exemplified by 2,3-diisopropylidene-5-norbornene, 2-ethylidene-3-isopropylidene-5-norbornene, 2-propenyl-2,2-norbornadiene, 1,3,7-octatrien, 1,4,9-decatrien, 5-vinyl-2-norbornene, 5-(2-propenyl)-2-norbornene, 5-(3-butenyl)-2-norbornene, 5-(4-pentenyl)-2-norbornene, 5-(5-hexenyl)-2-norbornene, 5-(5-heptenyl)-2-norbornene, 5-(7-octenyl)-2-norbornene, 5-methylene-2-norbornene, 6,10-dimethyl-1,5,9-undecatrien, 5,9-dimethyl-1,4,8-decatrien, 4-ethylidene-8-methyl-1,7-nonadiene, 13-ethyl-9-methyl-1,9,12-pentadecatrien, 5,9,13-trimethyl-1,4,8,12-tetradecadiene, 8,14,16-trimethyl-1,7,14-hexadecatrien and 4-ethylidene-12-methyl-1,11-pentadecadiene. These nonconjugated polyenes may be used singly or in combination of two or more. The nonconjugated polyene is preferably a nonconjugated polyene having 3 to 20 carbon atoms.

The nonconjugated polyene is preferably a nonconjugated diene, and more preferably 5-ethylidene-2-norbornene, dicyclopentadiene, or a combination of the both.

The ethylene-α-olefin-nonconjugated polyene copolymer rubbers of the component (A) are exemplified by ethylene-propylene-5-ethylidene-2-norbornene copolymer rubbers, ethylene-propylene-dicyclopentadiene copolymer rubbers and ethylene-propylene-5-ethylidene-2-norbornene dicyclopentadiene copolymer rubbers. These may be used singly or in combination of two or more.

With respect to the contents of an ethylene based monomer unit (ethylene unit) and an α-olefin-based monomer unit (α-olefin unit) in the component (A), preferably, the content of the ethylene unit is not less than 40% by weight and the content of the α-olefin unit is not more than 60% by weight, and more preferably, the content of the ethylene unit is not less than 45% by weight and the content of the α-olefin unit is not more than 55% by weight, based on 100% by weight of the total of the content of the ethylene unit and the content of the α-olefin unit, in view of enhancing the durability of a vibration-proof material. Further, in view of enhancing the vibration proofness of the vibration-proof material, preferably, the content of the ethylene unit is not more than 80% by weight and the content of the α-olefin unit is not less than 20% by weight, and more preferably, the content of the ethylene unit is not more than 65% by weight and the content of the α-olefin unit is not less than 35% by weight. The content of the ethylene unit and the content of the α-olefin unit can be measured by infrared spectroscopy.

The content of a nonconjugated polyene-based monomer unit (nonconjugated polyene unit) in the component (A) is preferably not less than 5, more preferably not less than 8, as a measurement value of the iodine value, in view of enhancing the durability of a vibration-proof material. Further, in view of enhancing the vibration proofness of the vibration-proof material, the iodine value is preferably not more than 36, more preferably not more than 30. The iodine value can be determined by measuring the double bond amount originated from nonconjugated polyene by infrared spectroscopy and converting the double bond amount to the iodine value.

The Mooney viscosity (ML₁₊₄125° C.) of the component (A) is preferably not less than 50, more preferably not less than 80 in view of enhancing the vibration proofness of a vibration-proof material. Further, in view of enhancing the kneading processability of a rubber composition, the Mooney viscosity is preferably not more than 200. The Mooney viscosity can be measured according to JIS K6300-1994 with the test temperature of 125° C.

In the case where the component (A) is a combination of two or more copolymer rubbers, the content of the ethylene unit, the content of the α-olefin unit, the Mooney viscosity and the iodide value are evaluated as the whole combination. The component (A) may be used in a combination with an extender oil. A material in which an extender oil is added in the component (A) is called an oil extended rubber by those in the art.

The manufacturing method of the component (A) is not especially limited, and the component (A) can be manufactured by a conventional method. Polymerization catalysts for manufacturing the component (A) are exemplified by titanium-based catalysts, vanadium-based catalysts and metallocene catalysts.

The component (B) is a natural rubber. The Mooney viscosity (ML₁₊₄100° C.) of a natural rubber is preferably not less than 20, more preferably not less than 30 in view of enhancing the durability of a vibration-proof material. Further, in view of enhancing the kneading processability of a rubber composition, the Mooney viscosity is not more than 180, more preferably not more than 170. The Mooney viscosity can be measured according to JIS K6300-1994 with the test temperature of 100° C.

The component (C) is an organic peroxide, and is exemplified by dicumyl peroxide, 2,5-dimethyl-2,5-di(tert-butylperoxy)hexane, 2,5-dimethyl-2,5-di(benzoylperoxy)hexane, 2,5-dimethyl-2,5-(tert-butylperoxy)hexyne-3, di-tert-butyl peroxide, di-tert-butyl peroxide-3,3,5-trimethylcyclohexane and tert-butyl hydroperoxide. These may be used singly or in combination of two or more. The component (C) is preferably at least one selected from the group consisting of dicumyl peroxide, di-tert-butyl peroxide and di-tert-butyl peroxide-3,3,5-trimethylcyclohexane.

The component (D) is an aromatic amine compound, and is exemplified by N-phenyl-N′-isopropyl-p-phenylenediamine, N-phenyl-N′-(1,3-dimethylbutyl)-p-phenylenediamine, N-phenyl-N′-(3-methacryloyloxy-2-hydroxypropyl)-p-phenylenediamine, a 2,2,4-trimethyl-1,2-dihydroquinoline polymer, 6-ethoxy-1,2-dihydro-2,2,4-thimethyl-quinoline, N-phenyl-1-naphthylamine, alkylated diphenylamine, octylated diphenylamine, 4,4′-bis(α,α-dimethylbenzyl)diphenylamine, p-(p-toluenesulfonylamide)diphenylamine, N,N′-di-2-naphthyl-p-phenylenediamine and N,N′-diphenyl-p-phenylenediamine. These may be used singly or in combination of two or more. In view of improving the heat resistance, the component (D) is preferably an aromatic amine compound having four or more phenyl groups, and more preferably at least one selected from the group consisting of 4,4′-bis(α,α-dimethylbenzyl)diphenylamine, p-(p-toluenesulfonylamide)diphenylamine, N,N′-di-2-naphthyl-p-phenylenediamine and N,N-diphenyl-p-phenylenediamine.

The component (E) is a silica and can be exemplified by a dry silica and a wet silica. These may be used singly or in combination of two or more. The BET specific surface area of the component (E) is preferably 20 to 150 m²/g, more preferably 30 to 60 m²/g, still more preferably 40 to 50 m²/g. The BET specific surface area is measured according to ASTM D1993-03.

The rubber composition of the present invention contains the above-mentioned components (A), (B), (C), (D) and (E). In the rubber composition of the present invention, with respect to 100 parts by weight of the total of the component (A) and the component (B), it is preferable that the content of the component (A) be 30 to 95 parts by weight; that of the component (B) be 5 to 70 parts by weight; that of the component (C) be 0.1 to 15 parts by weight; that of the component (D) be 0.01 to 15 parts by weight; and that of the component (E) be 0.5 to 50 parts by weight.

In view of enhancing the heat resistance of the vibration-proof material, with respect to 100 parts by weight of the total of the component (A) and the component (B), it is preferable that the content of the component (A) be not less than 30 parts by weight and that of the component (13) be not more than 70 parts by weight; and it is more preferable that the content of the component (A) be not less than 40 parts by weight and that of the component (13) be not more than 60-parts by weight. In view of enhancing the vibration proofness of the vibration-proof material, with respect to 100 parts by weight of the total of the component (A) and the component (B), it is preferable that the content of the component (A) be not more than 95 parts by weight and that of the component (B) be not less than 5 parts by weight; and it is more preferable that the content of the component (A) be not more than 75 parts by weight and that of the component (B) be not less than 25 parts by weight.

The content of the component (C) is, in view of enhancing the vibration proofness of a vibration-proof material, preferably not less than 0.1 part by weight, more preferably not less than 1 part by weight with respect to 100 parts by weight of the total of the component (A) and the component (B). Further, in view of enhancing the durability of a vibration-proof material, the content of the component (C) is preferably not more than 15 parts by weight, more preferably not more than 10 parts by weight with respect to 100 parts by weight of the total of the component (A) and the component (B).

The content of the component (D) is, in view of enhancing the heat resistance, preferably not less than 0.01 part by weight, more preferably not less than 0.05 part by weight with respect to 100 parts by weight of the total of the component (A) and the component (B). Further, in view of enhancing the vibration proofness, the content of the component (D) is preferably not more than 10 parts by weight, more preferably not more than 5 parts by weight with respect to 100 parts by weight of the total of the component (A) and the component (B).

The content of the component (E) is, in view of enhancing the durability of a vibration-proof material, preferably not less than 5 parts by weight, more preferably not less than 12 parts by weight with respect to 100 parts by weight of the total of the component (A) and the component (B). Further, in view of enhancing the vibration proofness of a vibration-proof material, the content of the component (E) is preferably not more than 50 parts by weight, more preferably not more than 30 parts by weight with respect to 100 parts by weight of the total of the component (A) and the component (B).

The rubber composition of the present invention may contain another reinforcing agent, a plasticizer, a vulcanizer, a vulcanizing accelerator, a vulcanizing coagent, a processing aid, an antioxidant, a coupling agent, a resin such as polyethylene or polypropylene, and a rubber other than the component (A) and the component (B), in the ranges of not damaging the advantages of the present invention.

The another reinforcing agent other than silica can be exemplified by channel carbon blacks such as EPC, MPC and CC; furnace carbon blacks such as SAF, ISAF, HAF, MAF, FEF, SRF, GPF, APF, FF, CF, SCF and ECF; thermal carbon blacks such as FT and MT; acetylene carbon black; aluminum silicate; basic magnesium carbonate; activated calcium carbonate; heavy calcium carbonate; light calcium carbonate; mica; magnesium silicate; high styrene resins; cyclized rubbers; coumarone-indene resins; phenol-formaldehyde resins; vinyltoluene copolymerized resins; lignin; and magnesium hydroxide.

The plasticizer is exemplified by plasticizers usually used in the field of rubbers, such as process oil, lubricant, paraffin, liquid paraffin, petroleum asphalt, vaseline, coal tar pitch, castor oil, flaxseed oil, factice, beeswax, recinoleic acid, palmitic acid, barium stearate, calcium stearate, zinc laurate and atactic polypropylene. The plasticizer is preferably process oil.

In the case of adding a plasticizer, the content of the plasticizer is usually 1 to 150 parts by weight, preferably 2 to 100 parts by weight with respect to 100 parts by weight of the total of the component (A) and the component (B).

The vulcanizer is exemplified by sulfur.

In the case of adding a vulcanizer, the content of the vulcanizer is usually not less than 0.05 part by weight, preferably not less than 0.1 parts by weight with respect to 100 parts by weight of the total of the component (A) and the component (B) in view of enhancing the vibration proofness of a vibration-proof material. Further, in view of enhancing the heat resistance, the content of the vulcanizer is preferably not more than 5 parts by weight, more preferably not more than 3 parts by weight with respect to 100 parts by weight of the total of the component (A) and the component (B).

The vulcanizing accelerator is exemplified by tetramethylthiuram disulfide, tetraethylthiuram disulfide, tetrabuthylthiuram disulfide, dipentamethylenethiuram monosulfide, dipentamethylenethiuram disulfide, dipentamethylenethiuram tetrasulfide, N,N′-dimethyl-N,N-diphenylthiuram disulfide, N,N′-dioctadecyl-N,N′-diisopropylthiuram disulfide, N-cyclohexyl-2-benzothiazole-sulfenamide, N-oxydiethylene-2-benzothiazole-sulfenamide, N,N-diisopropyl-2-benzothiazole sulfenamide, 2-mercaptobenzothiazole, 2-(2,4-dinitrophenyl)mercaptobenzothiazole, 2-(2,6-diethyl-4-morpholinothio)benzothiazole, dibenzothiazyl-disulfide, diphenylguanidine, triphenylguanidine, diorthotolylguanidine, orthotolyl-bi-guanide, diphenylguanidine-phthalate, an acetoaldehyde-aniline reaction product, a butylaldehyde-aniline condensate, hexamethylenetetramine, acetaldehyde ammonia, 2-mercaptoimidazoline, 2-mercaptobenzimidazole, thiocarbanilide, diethylthiourea, dibutylthiourea, trimethylthiourea, diorthotolylthiourea, zinc dimethyldithiocarbamate, zinc diethylithiocarbamate, zinc di-n-butyldithiocarbamate, zinc ethylphenyldithiocarbamate, zinc butylphenyldithiocarbamate, sodium dimethyldithiocarbamate, selenium dimethyldithiocarbamate, tellurium diethyldithiocarbamate, zinc dibutylxanthogenate and ethylene thiourea.

In the case of adding a vulcanizing accelerator, the content of the vulcanizing accelerator is usually not less than 0.05 part by weight, preferably not less than 0.1 parts by weight with respect to 100 parts by weight of the total of the component (A) and the component (B) in view of enhancing the vibration proofness of a vibration-proof material. Further, in view of reducing the generation of bloom, the content of the vulcanizing accelerator is preferably not more than 20 parts by weight, more preferably not more than 8 parts by weight with respect to 100 parts by weight of the total of the component (A) and the component (B).

The vulcanizing coagent includes polyfunctional monomers and metal oxides. The polyfunctional monomers are exemplified by triallyl isocyanurate, N,N′-m-phenylenebismaleimide, methacrylic acid, methyl methacrylate, ethyl methacrylate, propyl methacrylate, isopropyl methacrylate, n-butyl methacrylate, i-butyl methacrylate, sec-butyl methacrylate, t-butyl methacrylate, 2-ethylhexyl methacrylate, cyclohexyl methacrylate, isodecyl methacrylate, lauryl methacrylate, tridecyl methacrylate, stearyl methacrylate, 2-hydroxyethyl methacrylate, hydroxypropyl methacrylate, polyethylene glycol monomethacrylate, polypropylene glycol monomethacrylate, 2-ethoxyethyl methacrylate, tetrahydrofurfuryl methacrylate, allyl methacrylate, glycidyl methacrylate, benzyl methacrylate, dimethylaminoethyl methacrylate, diethylaminoethyl methacrylate, methacryloxyethyl phosphate, 1,4-butanediol diacrylate, ethylene glycol dimethacrylate, 1,3-butylene glycol dimethacrylate, neopentyl glycol dimethacrylate, 1,6-hexanediol dimethacrylate, diethylene glycol dimethacrylate, triethylene glycol dimethacrylate, polyethylene glycol dimethacrylate, dipropylene glycol dimethacrylate, polypropylene glycol dimethacrylate, trimethylolethane trimethacrylate, trimethylolpropane trimethacrylate, allyl glycidyl ether, N-methylolmethacrylamide, 2,2-bis(4-methacryloxypolyethoxyphenyl)propane, aluminum methacrylate, zinc methacrylate, calcium methacrylate, magnesium methacrylate and 3-chloro-2-hydroxypropyl methacrylate. The metal oxides are exemplified by magnesium oxide and zinc oxide, and preferably zinc oxide.

In the case of adding a polyfunctional monomer as a vulcanizing coagent, the content of the polyfunctional monomer is preferably not less than 0.05 part by weight, more preferably not less than 0.1 parts by weight with respect to 100 parts by weight of the total of the component (A) and the component (B) in view of enhancing the vibration proofness of a vibration-proof material. Further, in view of enhancing the durability, the content of the polyfunctional monomer is preferably not more than 15 parts by weight, more preferably not more than 8 parts by weight with respect to 100 parts by weight of the total of the component (A) and the component (B). In the case of adding a metal oxide as a vulcanizing coagent, the content of the metal oxide is usually 1 to 20 parts by weight with respect to 100 parts by weight of the total of the component (A) and the component (B).

The antioxidant includes compounds containing a hydrazine derivative and compounds containing a monosulfide bond. The compounds containing a hydrazine derivative include, for example, adipic acid dihydrazide, sebacic acid dihydrazide, dodecanedioic acid dihydrazide, isophthalic acid dihydrazide, propionic acid hydrazide, salicylic acid hydrazide, 3-hydroxy-2-naphthoic acid hydrazide, benzophenone hydrazone, aminopolyacrylamide, N,N′-bis[3-(3,5-di-t-butyl-4-hydroxyphenyl)propionyl]hydrazine, 4-amino-1,2,4-triazole, 3-amino-1,2,4-triazole, 1,2,4-triazole, 1,2,3-triazole, 1-hydroxybenzotriazol, 5-amino-1,2,4-triazole-3-carboxylic acid, 1,2,4-triazole-3-carboxylic acid, 1,2,4-triazole-3-carboxylic acid methyl ester, 3-mercapto-1,2,4-triazole, isopropylhydrazine sulfates, tert-butylhydrazine sulfates, 1-aminopyrrolidine, 3,5-dimethylpyrazole and 3-methyl-5-pyrazolone. The compounds containing a monosulfide bond include, for example, tetramethylthiuram monosulfide.

In the case where a compound containing a hydrazine derivative is added as the antioxidant, in view of enhancing the antioxidant performance, the content of the compound containing a hydrazine derivative is preferably 0.01 to 15 parts by weight, more preferably 0.05 to 8 parts by weight, with respect to 100 parts by weight of the total of the component (A) and the component (B). The compound containing a hydrazine derivative may be used singly or in combination of two or more.

In the case where a compound containing a monosulfide bond is added as the antioxidant, in view of enhancing the antioxidant performance, the content of the compound containing a monosulfide bond is preferably 0.05 to 10 parts by weight, more preferably 0.5 to 8 parts by weight, with respect to 100 parts by weight of the total of the component (A) and the component (B).

The coupling agent includes, for example, γ-chloropropyl trimethoxysilane, vinyltrichlorosilane, vinyltriacetoxysilane, vinyltriethoxysilane, vinyltrimethoxysilane, vinyltris(β-methoxyethoxy)silane, γ-methacryloxypropyl trimethoxysilane, γ-methacryloxypropylmethyl dimethoxysilane, β-(3,4-epoxycyclohexyl)ethyl trimethoxysilane, γ-glycidoxypropyl trimethoxysilane, γ-glycidoxypropylmethyl dimethoxysilane, γ-glycidoxypropylmethyl diethoxysilane, γ-mercaptopropyl trimethoxysilane, bis(3-triethoxysilylpropyl) tetrasulfide, bis(3-triethoxysilylpropyl) disulfide, amino-functionalized silane, γ-aminopropyltriethoxysilane, N-phenyl-γ-aminopropyl trimethoxysilane, N-β-(aminoethyl)-γ-aminopropylmethyl dimethoxysilane, γ-(polyethyleneamino)propyl trimethoxysilane, N-β-(aminoethyl)-γ-aminopropyl trimethoxysilane, γ-ureidopropyl triethoxysilane, N′-vinylbenzyl-N-trimethoxysilylpropylethylenediamine salts, methacrylate-chromium chloride complex, 3-isocyanatepropyltriethoxysilane, 3-acryloxyprophyltrimethoxysilane, acetoalkoxyaluminum diisopropylate, isopropyltriisostearoyl titanate, isopropyltris(dioctylpyrophosphate) titanate, isopropyltri(N-aminoethyl-aminoethyl) titanate, tetraoctylbis(ditridecylphosphite) titanate, tetra(2,2-diallyloxymethyl-1-butyl)bis(ditridecyl)phosphite titanate and bis(dioctylpyrophosphate)oxyacetate titanate.

In the case where a coupling agent is added, in view of enhancing the tensile strength, the content of the coupling agent is preferably not less than 0.05 part by weight, more preferably not less than 0.1 part by weight, with respect to 100 parts by weight of the total of the component (A) and the component (B). In view of retaining the heat resistance, the content of the coupling agent is preferably not more than 10 parts by weight, more preferably not more than 5 parts by weight, with respect to 100 parts by weight of the total of the component (A) and the component (B).

Rubbers other than the component (A) and the component (B) are exemplified by styrene-butadiene rubber, chloroprene rubber, acrylonitrile-butadiene rubber, acrylic rubber, butadiene rubber, liquid polybutadiene, modified liquid polybutadiene, liquid isoprene and modified liquid isoprene. The content of the rubber component is usually not more than 50 parts by weight with respect to 100 parts by weight of the total of the component (A) and the component (B).

The rubber composition of the present invention can be manufactured by a preparation method of general rubber compounds. A manufacturing method of a rubber composition related to the present invention includes, for example, a manufacturing method having the following steps (1) and (2).

The step (1) involves kneading at least the components (A), (B), (D) and (E) to obtain a kneaded product. The step (2) involves mixing the kneaded product obtained in the step (1) with at least a component (C).

The kneading in the step (1) is performed by a conventional internal kneader such as a Banbury mixer or a kneader. The kneading temperature is usually 40 to 250° C.; and the kneading time is usually 0.5 to 30 min.

The mixing in the step (2) is performed using a roll, a kneader or the like. The mixing temperature is preferably not more than the decomposition temperature of the component (C) (for example, not more than 100° C.). The mixing time is usually 0.5 to 60 min.

In the steps (1) and (2) each, as required, the above-mentioned reinforcing agent other than silica, plasticizer, vulcanizer, vulcanizing accelerator, vulcanizing coagent, processing aid, antioxidant, coupling agent, resin, and rubber are added.

The rubber composition of the present invention is molded into a prescribed shape by a molding machine such as an extrusion molding machine, an injection molding machine, a calendar roll machine or a compression molding machine; and the composition is vulcanized simultaneously with molding or heat treatment of a molded body; and the vulcanized product is used as a vibration-proof material. The temperature and time of the heat treatment are those at which the component (C) contained in the rubber composition can be decomposed. The heat treatment temperature is usually not less than 120° C., preferably 140 to 220° C. The heat treatment time is usually 1 to 60 mm.

The vibration-proof material of the present invention is excellent in a balance among the vibration proofness, durability and heat resistance. Therefore, the vibration-proof material of the present invention is processed into prescribed shapes and used as vibration-proof rubber products such as engine mounts, muffler hangers and strut mounts.

### EXAMPLES

Then, the present invention will be described by way of Examples, but the scope of the present invention is not limited thereto.

[Measurement and Evaluation Methods]

### (1) The Content of the Ethylene Unit and the Content of the Propylene Unit

A copolymer rubber was formed into a film of about 0.1 mm in thickness by a hot press; the infrared absorption spectrum of the film was measured by an infrared spectrophotometer (IR-810, made by JASCO Corp.); and the content of the ethylene unit and the content of the propylene unit were determined according to the method described in documents (Takayama, Usami, et al., “Characterization of polyethylene by infrared absorption spectrum”, in Japanese; Mc Rae, M. A., Madam S, W. F. et al., Die Makromolekulare Chemie, 177, 461 (1976)).

### (2) Iodine Value

A copolymer rubber was formed into a film of about 0.5 mm in thickness by a hot press; a peak (absorption peak of 1688 cm⁻¹) originated from 5-ethylidene-2-norbornene of the film was measured by an infrared spectrophotometer to determine the molar content of double bond in the copolymer rubber; and the iodine value was calculated from the molar content.

### (3) Mooney Viscosity

The Mooney viscosity (ML₁₊₄100° C.) of 100° C. was measured at a test temperature of 100° C. and the Mooney viscosity (ML₁₊₄125° C.) of 125° C. was measured at a test temperature of 125° C. according to JIS K6300-1994.

### (4) BET Specific Surface Area

The BET specific surface area of the (E) silica was measured according to ASTM D1993-03.

### (5) Dynamic Multiplication

A strip-shaped No. 1 test piece standardized according to JIS K6254-1993 was cut out from a vulcanized sheet. Then, the static shear modulus of the test piece was measured by a tensile tester (trade name “TENSILON RTC-1210A”, made by A&D Co., Ltd.) under the test conditions of an atmospheric temperature of 23° C. and a tensile rate of 50 mm/min according to JIS 6254-1993 “5. Low deformation tensile test”; and a value obtained by multiplying the value of the static shear modulus by three was defined as a static modulus. The dynamic modulus was measured using a strip-shaped No. 1 test piece standardized according to, prescribed in JIS K6254-1993, whose entire length was made 50 mm, by a vibration-proofing characteristics automatic tester (made by Yoshimizu Corp.) under the conditions of an atmospheric temperature of 23° C., a vibration frequency of 100 Hz and a vibration amplitude of ±0.1%. A value obtained by dividing the dynamic modulus by the static modulus was defined as a dynamic multiplication. The lower this value is, the more excellent the vibration proofness is.

### (6) Tear Strength

An angle-shaped test piece standardized according to JIS K6252-1993 was cut out from a vulcanized sheet. Then, the tear strength of the test piece was measured by a tensile tester (trade name “QUICK READER P-57”, made by Ueshima Seisakusho Co., Ltd.) under the conditions of an atmospheric temperature of 23° C. and a tensile rate of 500 mm/min. The higher this value is, the more excellent the durability is.

### (7) Compression Set

A small test piece standardized according to JIS K6262-1997 was prepared, pressed by 25% using a pressing machine, and allowed to stand in a gear oven at an atmospheric temperature of 120° C. for 70 hours; thereafter, the press was released at an atmospheric temperature of 23° C.; then the recovery rate of the test piece was measured. The lower rate indicates the more excellent heat resistance.

(Preparation of Rubber Compositions)

Components described below were kneaded in proportions (parts by weight) shown in Table 1 to obtain rubber compositions.

### Component (A)

An ethylene-propylene-5-ethylidene-2-norbornene copolymer rubber (trade name: Esplene 553, made by Sumitomo Chemical Co., Ltd., ethylene content: 52% by weight, propylene content: 48% by weight (the total of both the contents is 100% by weight), Mooney viscosity (ML₁₊₄125° C.): 100, and iodine value: 10)

### Component (B)

A natural rubber (Mooney viscosity (ML₁₊₄100° C.): 65)

### Component (C)

Dicumyl peroxide (made by NOF Corp., a 40% diluted product)

### Component (D)

D-1: 4,4′-bis(α,α-dimethylbenzyl) diphenylamine

D-2: N,N′-di-2-naphthyl-p-phenylenediamine

### Component (E)

E-1: A wet silica (made by Tosoh Silica Corp., trade name: Nipsil E743, BET specific surface area: 45 m²/g)

E-2: A wet silica (made by Tosoh Silica Corp., trade name: Nipsil E220A, BET specific surface area: 147 m²/g)

E-3: A wet silica (made by Tosoh Silica Corp., trade name: Nipsil SS50, BET specific surface area: 150 m²/g)

E-4: A wet silica (made by Tosoh Silica Corp., trade name: Nipsil VN3, BET specific surface area: 205 m²/g)

E-5: A wet silica (made by Tosoh Silica Corp., trade name: Nipsil L300, BET specific surface area: 208 m²/g)

E-6: A wet silica (made by Tosoh Silica Corp., trade name: Nipsil BD-2, BET specific surface area: 305 m²/g)

E-7: A dry silica (made by Nihon Aerosil Co., Ltd. trade name: Aerosil 200, BET specific surface area: 200 m²/g)

Processing aid: stearic acid
Vulcanizing coagent: zinc oxide
Vulcanizing accelerator: 2-mercaptobenzimidazole
Antioxidant: 2,2,4-trimethyl-1,2-dihydroquinoline polymer
Coupling agent: γ-mercaptopropyltrimethoxysilane

### Example 1

40 parts by weight of ethylene-propylene-5-ethylidene-2-norbornene copolymer rubber as a component (A), 60 parts by weight of a natural rubber as a component (B), 1.5 parts by weight of 4,4′-bis(α,α-dimethylbenzyl) diphenylamine and 0.5 part by weight of N,N′-di-2-naphthyl-p-phenylenediamine as components (D), 5 parts by weight of silica (trade name “Nippil E473”, made by TOSOH SILICA CORPORATION) as components (E), and 5 parts by weight of zinc oxide, 1 part by weight of stearic acid, 0.5 part by weight of 2-mercaptobenzimidazole, 0.5 part by weight of 2,2,4-trimethyl-1,2-dihydroquinoline and 0.4 part by weight of γ-mercaptopropyltrimethoxysilane, were charged in a Banbury mixer of 1,700 mL at a starting temperature of 80° C., and kneaded at a rotor speed of 60 rpm for 5 nm to obtain a mixture. Then, to the mixture, 9 parts by weight of dicumyl peroxide (40% diluted) as a component (C) based on 100 parts by weight of the total of the component (A) and the component (B) was mixed by an 8-inch open roll to obtain a rubber composition.

### Example 2

A rubber composition was obtained by performing the same operations as in Example 1, except for using 15 parts by weight of “Nipsil E220A” in place of “Nipsil E743” as the component (E).

### Example 3

A rubber composition was obtained by performing the same operations as in Example 1, except for using 15 parts by weight of “Nipsil SS50” in place of “Nipsil E743” as the component (E).

### Example 4

A rubber composition was obtained by performing the same operations as in Example 1, except for using 15 parts by weight of “Nipsil VN3” in place of “Nipsil E743” as the component (E).

### Example 5

A rubber composition was obtained by performing the same operations as in Example 1, except for using 15 parts by weight of “Nipsil L300” in place of “Nipsil E743” as the component (E).

### Example 6

A rubber composition was obtained by performing the same operations as in Example 1, except for using 15 parts by weight of “Nipsil HD-2” in place of “Nipsil E743” as the component (E).

### Example 7

A rubber composition was obtained by performing the same operations as in Example 1, except for using 15 parts by weight of “Aerosil 200” in place of “Nipsil E743” as the component (E).

(Preparation of Vibration-Proof Materials)

The obtained rubber compositions were each pressed at 170° C. for 20 min to perform simultaneously molding and vulcanization to obtain a vulcanized sheet of 2 mm in thickness and a small test piece for compression set. The evaluation results of the vulcanized sheets and the test pieces for compression set are shown in Table 2.

TABLE 1

| | | | Example | | | | | | |
|---|---|---|---|---|---|---|---|---|---|
| Rubber composition | | Unit | 1 | 2 | 3 | 4 | 5 | 6 | 7 |
| Component (A) | | parts by | 40 | 40 | 40 | 40 | 40 | 40 | 40 |
| | | weight | | | | | | | |
| Component (B) | | parts by | 60 | 60 | 60 | 60 | 60 | 60 | 60 |
| | | weight | | | | | | | |
| Component (C) | | parts by | 9 | 9 | 9 | 9 | 9 | 9 | 9 |
| | | weight | | | | | | | |
| Component | D-1 | parts by | 1.5 | 1.5 | 1.5 | 1.5 | 1.5 | 1.5 | 1.5 |
| (D) | | weight | | | | | | | |
| | D-2 | parts by | 0.5 | 0.5 | 0.5 | 0.5 | 0.5 | 0.5 | 0.5 |
| | | weight | | | | | | | |
| Component | E-1 | parts by | 15 | — | — | — | — | — | — |
| (E) | | weight | | | | | | | |
| | E-2 | parts by | — | 15 | — | — | — | — | — |
| | | weight | | | | | | | |
| | E-3 | parts by | — | — | 15 | — | — | — | — |
| | | weight | | | | | | | |
| | E-4 | parts by | — | — | — | 15 | — | — | — |
| | | weight | | | | | | | |
| | E-5 | parts by | — | — | — | — | 15 | — | — |
| | | weight | | | | | | | |
| | E-6 | parts by | — | — | — | — | — | 15 | — |
| | | weight | | | | | | | |
| | E-7 | parts by | — | — | — | — | — | — | 15 |
| | | weight | | | | | | | |

| | | | | | | | | |
|---|---|---|---|---|---|---|---|---|
| Zinc oxide | parts by | 5 | 5 | 5 | 5 | 5 | 5 | 5 |
| | weight | | | | | | | |
| Stearic acid | parts by | 1 | 1 | 1 | 1 | 1 | 1 | 1 |
| | weight | | | | | | | |
| 2-mercaptobenzimidazole | parts by | 0.5 | 0.5 | 0.5 | 0.5 | 0.5 | 0.5 | 0.5 |
| | weight | | | | | | | |
| A polymer of 2,2,4-trimethyl-1,2- | parts by | 0.5 | 0.5 | 0.5 | 0.5 | 0.5 | 0.5 | 0.5 |
| dihydroquinoline | weight | | | | | | | |
| γ-mercaptopropyltrimethoxysilane | parts by | 0.4 | 0.4 | 0.4 | 0.4 | 0.4 | 0.4 | 0.4 |
| | weight | | | | | | | |

TABLE 2

| Vibration proof | | Example | | | | | | |
|---|---|---|---|---|---|---|---|---|
| material | Unit | 1 | 2 | 3 | 4 | 5 | 6 | 7 |
| Dynamic | — | 1.31 | 1.30 | 1.50 | 1.35 | 1.35 | 1.45 | 1.58 |
| multiplication | | | | | | | | |
| Tear strength | kN/m | 60 | 65 | 61 | 57 | 62 | 66 | 67 |
| Compression | % | 21 | 24 | 24 | 26 | 26 | 28 | 31 |
| set | | | | | | | | |

The present invention can provide a rubber composition which uses as a raw material rubber an ethylene-α-olefin-nonconjugated polyene copolymer rubber and gives a vibration-proof material excellent in a balance among the vibration proofness, durability and heat resistance by vulcanizing the rubber composition, and can provide a vibration-proof material obtained by vulcanizing the rubber composition.

What is claimed is:

1. A rubber composition comprising the following components:
(A): an ethylene-α-olefin-nonconjugated polyene copolymer rubber;
(B): a natural rubber;
(C): an organic peroxide;
(D): an aromatic amine compound; and
(E): silica.

2. The rubber composition according to claim 1, wherein the component (E) has a BET specific surface area of 30 to 60 m²/g.

3. The rubber composition according to claim 1, wherein the component (D) is an aromatic amine compound having at least four phenyl groups.

4. The rubber composition according to claim 1, wherein, with respect to 100 parts by weight of the total of the component (A) and the component (B), a content of the component (A) is 30 to 95 parts by weight; a content of the component (B) is 5 to 70 parts by weight; a content of the component (C) is 0.1 to 15 parts by weight; a content of the component (D) is 0.01 to 10 parts by weight; and a content of the component (E) is 0.5 to 50 parts by weight.

5. A vibration-proof material obtained by vulcanizing the rubber composition according to claim 1.
